(19) United States
(12) Patent Application Publication
(10) Pub. No.: US 2009/0122875 A1
(43) Pub. Date: May 14, 2009

(54) BUFFERING OF VIDEO STREAM DATA

(75) Inventor: Jacobus Maarten Den Hollander, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/817,686

(22) PCT Filed: Mar. 3, 2006
(86) PCT No.: PCT/IB2006/050669

§ 371 Date: Sep. 4, 2007

(30) Foreign Application Priority Data
Mar. 7, 2005 (EP) 05101731.7

(51) Int. Cl. H04N 7/12

(52) U.S. Cl. 375/240.25; 375/E07.026

(57) ABSTRACT

Buffering of a video stream containing intra frames (I-frames) and inter frames (P-frames, B-frames) is disclosed. A buffer memory is segmented in two parts, a contiguous part for buffering of contiguous frames of the video stream (I-, P- and B-frames), and an intra part for the buffering of intra frames of the video stream. A decoding of the video stream may under normal conditions be done on data read from the contiguous part of the buffer, whereas the decoding of the video stream in a buffer-underrun situation may be done on data read from the intra buffer

### FIELD OF THE INVENTION

The invention relates to buffering of a video stream, and in particular to buffering of a video stream containing intra frames and inter frames.

### BACKGROUND OF THE INVENTION

Present day storage devices, such as optical storage devices used in connection with video playback are becoming so fast that the supply rates of the storage devices exceed the playback rate of the video stream, examples of devices include stand-alone electronic apparatuses and hard disk based devices. This typically leads to a buffer implementation where compressed video is read into a buffer from which it is decoded before presentation to a user. The buffer is supplied with data at a sufficient rate, so that enough data is present in the buffer for a user viewing a film to experience a continuous flow of images.

Video formats are highly standardized, and important formats include the highly compressed MPEG formats. Three types of pictures of video information are used in an MPEG format, intra frames (I-frames), and two types of inter frames (P-frames and B-frames). Intra frames are encoded and decoded independently from other pictures in a video stream. Predictive frames (P-frames) are forward predictive frames that are encoded and decoded relative to a most recent past reference picture, the reference picture being a P-frame or an I-frame. Bi-directional frames (B-frames) are related to both previous and future reference pictures. A frame cannot simply be decoded, displayed and disregarded due to the interrelations between frames, and frames are retained in the frame buffer at least until all other frames depending on a frame have been decoded for display.

U.S. Pat. No. 5,909,224 deals with an MPEG decoder where the frame buffer is comprising four buffers for handling buffering of I-frames, P-frames and B-frames where a buffer can be freed of obsolete data so that video data decoding is accelerated. The disclosure does not, however, deal with decoding of streamed video data in a failure situation, where an interruption of the data stream occurs so that the buffer runs low.

The inventor of the present invention has appreciated that an improved technique for ensuring graceful degradation in a failure situation where an interruption of the data stream occurs is of benefit, and has in consequence devised the present invention.

### SUMMARY OF THE INVENTION

The present invention seeks to provide an improved way of handling a frame buffer. Preferably, the invention alleviates, mitigates or eliminates one or more of the above or other disadvantages singly or in any combination.

Accordingly there is provided, in a first aspect, a device for buffering a video stream comprising intra frames and inter frames, wherein the device comprising a buffer memory being segmented in two parts, a contiguous part for buffering of contiguous frames of the video stream, and an intra part for the buffering of intra frames of the video stream.

The device may be part of a device for managing a frame buffer on an apparatus suitable for playback of streamed video, such apparatuses include, but are not limited to, apparatuses based on playback from optical disks, hard disks or other magnetic storage means, as well as semiconductor storage means.

The functionality provided by the device can advantageously be used in connection with apparatuses where the buffer is in risk of running low. This can be due to vibration or shock in connection with video playback in a car, a train, a plane, etc.; due to dirt on a disk resulting in reduced playability; due to multiple applications using the same storage device, e.g. with a hard disk present on a server, or for any other reason.

The contiguous frames include both the intra frames and the inter frames so that the video stream may be decoded entirely from the data in the contiguous part.

It is an advantage to segment the buffer into a contiguous part and an intra part, since a buffer can effectively be enlarged without physically enlarging the size of the buffer, i.e. without adding extra costs to the bill of materials. Buffering of video requires a lot of memory which is expensive. As an example, buffering of 10 sec. of compressed video with a bit-rate of 2 Mbits/s—in this case 20 Mbits equal to 2.5 Mbyte is needed.

Although the intra frames are the larges frames of all frames in terms of bytes, they appear the least number of times in a stream. Especially for highly compressed video streams such as DivX and MPEG4 may the distance between intra frames be large, even as much as 3 seconds. By dedicating a part of the buffer memory only to intra frames, may the effective memory in terms of available playback time be enlarged, even though the viewing quality of the video signal may be degraded since viewing of intra frames is “slide show”-like. The advantage is that a frozen video screen is avoided.

The optional features as defined in claim 2 are advantageous since many standard formats, e.g. the MPEG formats and the DivX format, use I-frames, P-frames and B-frames, and consequently may the device readily be implemented for use in connection with such standard formats.

The optional features as defined in claim 3 are advantageous since full quality of the video data is maintained during normal operation, however in a failure situation, where an interruption of the data stream may occur so that the buffer runs low, frozen video on the screen until the drive recovers is avoided.

The optional features as defined in claim 4 are advantageous since by fixing the size of the buffer segments, a size appropriate for most situations can be decided by a maker of the device and no pre-analysis of the video content may be necessary, ensuring fast access to the video data.

The optional features as defined in claim 5 are advantageous since for devices possessing the sufficient computational capacity, the streamed data can be analysed in the course of streaming and the segment sizes be optimised continuously in accordance with the nature of the video data, a situation of use, or for any other reason.

The optional features as defined in claim 6 are advantageous since the segment sizes can be adapted to the type of video data, different types of video data may possess different ratios of intra frames and inter frames. Action films may, e.g., comprise many scene shifts and may consequently possess a higher number of inter frames than e.g. emotional art films.

The optional features as defined in claims 7 and 8 are advantageous by ensuring a minimum size of the intra buffer, a maker of the device may design a worst case scenario in which the device should be able to avoid frozen images on the screen.

According to a second aspect of the invention is provided a system for preparing video signals, the system comprising:

a stream handling section for handling a received an encoded video stream comprising intra frames and inter frames, and for providing the video stream to a buffer section,

a buffer section, including a buffer, for handling the buffering of the video stream,

a decoder for decoding the video stream,

an output section for outputting the decoded video stream, and

a controller for controlling the interoperability of the system

wherein the buffer is segmented in two parts, a contiguous part for buffering of contiguous frames of the video stream, and an intra part for the buffering of intra frames of the video stream.

The system may be part of the buffer managing system in an apparatus suitable for playback of streamed video. Apparatuses manufactured without the functionality of the present invention may be provided with this functionality by updating the controller for controlling the interoperability of the system. The device according to the first aspect of the present invention may form part of the system according to the second aspect of the invention, by forming part of, or constituting, at least some of the elements of the system according to the second aspect of the invention.

According to a third aspect of the invention is provided computer readable code for controlling a buffer memory according to the first aspect of the invention. The controller according to the second aspect of the invention may include computer code according to the third aspect of the invention.

According to a fourth aspect of the invention is provided a data stream in a buffer-underrun situation, the data stream being based on a normal situation data stream comprising intra frames and inter frames, wherein the buffer memory being segmented in two parts, a contiguous part for buffering of contiguous frames of the normal situation video stream, and an intra part for the buffering of intra frames of the normal situation video stream, and wherein the data stream in the buffer-underrun situation only comprises frames from the intra buffer.

According to a fifth aspect of the invention is provided a method for managing a buffer memory according to the present invention.

In general may the various aspects of the invention may be combined and coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 schematically illustrates an embodiment of the present invention, and

FIG. 2 schematically illustrates a mode of operation of the present invention.

### DESCRIPTION OF PREFERRED EMBODIMENTS

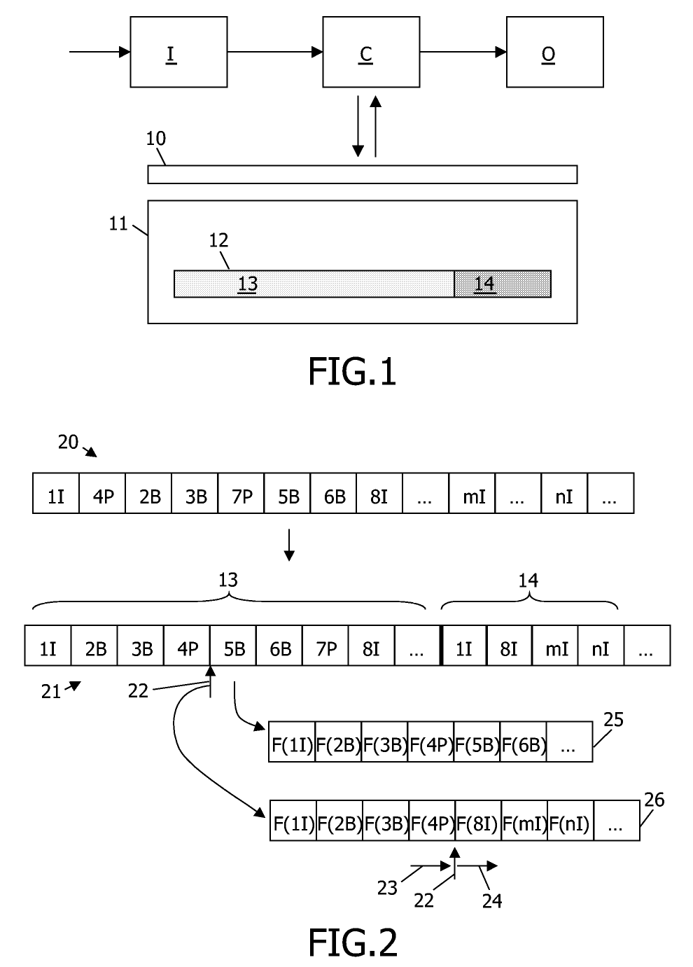

A schematic illustration of an embodiment of the present invention is provided in FIG. 1. The Figure comprises a stream handling section I for handling a received and encoded video stream comprising intra frames and inter frames and for providing the video stream to a buffer section, an output section O for outputting the decoded video stream, a decoder 10 for decoding the video stream, a buffer section 11, including a buffer 12, for handling the buffering of the video stream, and a controller C for controlling the interoperability of the system. The invention is not limited to an implementation as illustrated in FIG. 1, the implementation is only shown for illustrative purposes—any implementation within the scope of invention may be envisioned.

The buffer 12 is segmented in two parts, a contiguous part 13 for buffering of contiguous frames of the video stream, and an intra part 14 for the buffering of intra frames of the video stream.

In the following is focused on an embodiment where the video stream comprising intra frames (I-frames) and where the inter frames are in the form of predictive frames (P-frames) and/or bi-directional frames (B-frames). FIG. 2 schematically illustrates such a decoded video signal 20. In the streamed video signal are the frames (as an example) arranged in the order: 1I, 4P, 2B, 3B, 7P, 5B, 6B, 8I being the first group of pictures (GOP) and followed by addition GOPs including intra frames mI, nI, where m, n are label indexes for counting the frame number, m<n. The frames are arranged 21 in the frame buffer 12 in the correct display order: 1I, 2B, 3B, 4P, 5B, 6B, 7P, 8I, . . . where the contiguous part 13 contains all frames and the intra part 14 contains only the intra frames 1I, 8I, mI, nI, . . . Obsolete frames are continuously emptied from the buffer in a streaming session.

The decoded video stream under normal conditions is based on data read from the contiguous part of the buffer. In a normal situation, the frames comprised in the intra part are not used, and the displayed video 25 is build up from the contiguous frames (F(1I)+ . . . +F(8I)+ . . . ). Decoding of the video stream in a buffer-underrun situation, on the other hand, is done based on data read from the intra buffer. As an example, a buffer underrun situation occurs at a time instant 22 resulting in that the displayed video 26 up to underrun time instant 22, 23 is based on frames from the contiguous buffer, but after 24 the underrun time instant, the displayed video frames are based on frames from the intra buffer.

To illustrate the gain in effective buffer size for a buffer in accordance with the present invention, five DVD movies/demos in the MPEG2 format have been analysed with respect to the number of I, P and B-frames (#I, #P, #B), the total sizes of the frames (TABLE 1.1) as well as the average sizes of the frames, and two gain estimates (TABLE 1.2). The analysis is made for the MPEG2 format, for an even more compressed format such as the MPEG4 AVC (Advance Video Coding) format, where the improved overall compression results in a 50% lower data rate at the same signal-to-noise ratio, and where the GOP size is larger, meaning that the distance between two consecutive I-frames is larger, and where the B-frame size is smaller. It is expected that the effect of the larger GOP size is more or less compensated by the relatively larger I-frame size, so that a gain in MPEG4 with respect to MPEG2 is roughly a factor two.

TABLE 1.1

| Stream Name | | | | | | |
|---|---|---|---|---|---|---|
| (size ~50 M) | #I | #P | #B | Total size of I (bytes) | Total size of P (bytes) | Total size of B (bytes) |
| Eyes on DVD (Demo) | 109 | 365 | 885 | 8641244 | 18024833 | 23790013 |
| part 1 | | | | | | |
| Eyes on DVD (Demo) part 2 | 102 | 378 | 910 | 8573213 | 17031951 | 24432760 |
| Intorelable Cruelty part 1 | 123 | 487 | 804 | 14948416 | 20388953 | 15549268 |
| Intorelable Cruelty part 2 | 122 | 464 | 800 | 12582533 | 21234332 | 17759108 |
| Shrek 2 part 1 | 110 | 331 | 822 | 12085845 | 19449018 | 20369545 |
| Shrek 2 part 2 | 138 | 418 | 977 | 13630364 | 19145514 | 18621301 |
| Speed part 1 | 198 | 775 | 1929 | 9021328 | 16354683 | 26612091 |
| Speed part 2 | 189 | 754 | 1874 | 7977579 | 17383148 | 26292032 |
| Mission Impossible part 1 | 183 | 718 | 1784 | 8608949 | 17421199 | 25905161 |
| Mission Impossible | 183 | 715 | 1782 | 9479221 | 16826358 | 25551524 |
| part 2 | | | | | | |
| | | | Avr. | 10554869.2 | 18325998.9 | 22488280.3 |

TABLE 1.2

| | Avr size I | Avr size P | Avr size B | Gain | |
|---|---|---|---|---|---|
| Stream Name (size ~50 M) | (bytes) | (bytes) | (bytes) | (I + P + B)/I | Gain (I + [symbol] B + mP)/I |
| Eyes on DVD (Demo) part 1 | 79277 | 49383 | 26881 | 5.8 | 30.3 |
| Eyes on DVD (Demo) part 2 | 84051 | 45058 | 26849 | 5.8 | 34.0 |
| Intorelable Cruelty part 1 | 121531 | 41866 | 19339 | 3.4 | 21.0 |
| Intorelable Cruelty part 2 | 103135 | 45763 | 22198 | 4.1 | 22.4 |
| Shrek 2 part 1 | 109871 | 58758 | 24780 | 4.3 | 24.9 |
| Shrek 2 part 2 | 98770 | 45802 | 19059 | 3.8 | 22.6 |
| Speed part 1 | 45562 | 21102 | 13795 | 5.8 | 39.2 |
| Speed part 2 | 42209 | 23054 | 14029 | 6.5 | 39.5 |
| Mission Impossible part 1 | 47043 | 24263 | 14520 | 6.0 | 38.4 |
| Mission Impossible part 2 | 51799 | 23533 | 14338 | 5.5 | 37.9 |
| | | | Avr. | 4.9 | 31.0 |

[symbol]

indicates data missing or illegible when filed

As a first example is the gain of storing only I-frames in the buffer compared to storing a GOP comprising one I-frame, one P-frame and one B-frame calculated for the various DVD films. Typically, a GOP consists of multiple P-frames and B-frames, therefore the average gain of 4.9 found from this analysis is a very conservatively estimated gain. Assuming that every GOP contains one I-frame and that all P and B-frames are equally distributed over the GOPs, a gain of 31 (±10) is found. This gain is expected to correspond to a typical gain obtained by using the present invention for a typical film.

A chosen ratio between the size of the intra buffer and the inter buffer may depend upon a number of factors, including a typical situation of use. As discussed above a specific gain depends strongly on the GOP size. As an example of the relationship between the gain, the size ratio and playtime, a gain is assumed to be 10 or better. For such a gain, a ratio of 91% contiguous buffer and 9% intra buffer may be used. This results in 80% longer playtime in the buffer compared to a situation where a buffer is filled 100% with contiguous data (91% contiguous+10×9% intra=180%). 91% is mentioned as an example, at least 80% of the buffer may be allocated to the contiguous buffer, or an amount in the range 85% to 95% may be allocated to the contiguous buffer. The specific size ratio may partly or entirely depend upon an expected gain, an estimated gain or a measured gain, etc.

In a failure situation, where an interruption of the data stream occurs so that the buffer runs low, a number of scenarios can occur depending upon the apparatus in question. For an optical disk drive, 3-4 seconds may be used trying to retrieve the data. In a situation where a first attempt trying to retrieve the data is unsuccessful, may the application controlling the drive order the drive to try again, resulting in that the drive may be busy for another 3-4 seconds. Retries issued by the application can occur several times. Consequently, the size of the intra buffer may be such, that enough I-frames may be stored so as to overcome at least these 3-4 seconds. However, the size of the intra buffer may be determined based on alternative scenarios, so that the size of the intra buffer may be larger, for example sufficiently large for storing between 5 and 10 seconds of I-frames, or even larger.

Although the present invention has been described in connection with preferred embodiments, it is not intended to be limited to the specific form set forth herein. Rather, the scope of the present invention is limited only by the accompanying claims.

In this section, certain specific details of the disclosed embodiment such as specific formats, types of apparatuses, buffer sizes, etc., are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. Device for buffering a video stream comprising intra frames and inter frames, wherein the device comprising a buffer memory (12) being segmented in two parts, a contiguous part (13) for buffering of contiguous frames of the video stream, and an intra part (14) for the buffering of intra frames of the video stream.

2. Device according to claim 1, wherein the video stream comprising intra frames (I-frames) and predictive frames (P-frames) and/or bi-directional frames (B-frames), and wherein the buffer memory (12) is segmented in two parts, one part (13) for the buffering of contiguous frames of the video stream, and one part (14) for the intra frames of the video stream.

3. Device according to claim 1, wherein a decoding of the video stream under normal conditions (25) is done on data read from the contiguous part of the buffer, and wherein the decoding of the video stream in a buffer-underrun situation (26) of the contiguous part of the buffer is done on data read from the intra buffer.

4. Device according to claim 1, wherein a size of the buffer segments are fixed, so that the size of the segments allocated to the contiguous part and to the intra part is a fixed property of the device.

5. Device according to claim 1, wherein a size of the buffer segments can be updated dynamically, so that the size of the segments allocated to the contiguous part and to the intra part can be changed during a streaming session of the video stream.

6. Device according to claim 1, wherein a size of the buffer segments can be determined prior to streaming of specific video data, based upon an analysis of the ratio of intra to inter frames of the specific video stream.

7. Device according to claim 1, wherein the buffer memory is segmented so that at least 85% of the total buffer memory is allocated to the contiguous part

8. Device according to claim 1, wherein the size of the intra buffer corresponds to at least 3 seconds of video playback.

9. System for preparing video signals, the system comprising:
a stream handling section (I) for handling a received an encoded video stream comprising intra frames and inter frames, and for providing the video stream to a buffer section (12),
a buffer section (12), including a buffer, for handling the buffering of the video stream,
a decoder (10) for decoding the video stream,
an output section (0) for outputting the decoded video stream, and
a controller (C) for controlling the interoperability of the system
wherein the buffer (12) is segmented in two parts, a contiguous part (13) for buffering of contiguous frames of the video stream, and an intra part (14) for the buffering of intra frames of the video stream.

10. Computer readable code for controlling a buffer memory as claimed in claim 1.

11. Data stream in a buffer-underrun situation (26), the data stream being based on a normal situation data stream (25) comprising intra frames and inter frames, wherein the buffer memory being segmented in two parts, a contiguous part for buffering of contiguous frames of the normal situation video stream, and an intra part for the buffering of intra frames of the normal situation video stream, and wherein the data stream in the buffer-under run situation (24) only comprises frames from the intra buffer.

12. Method for managing a buffer memory for a video stream comprising intra frames and inter frames, wherein the buffer memory being segmented in two parts, a contiguous part for buffering of contiguous frames of the video stream, and an intra part for the buffering of intra frames of the video stream.
